(19) United States
(12) Patent Application Publication
(10) Pub. No.: US 2003/0025388 A1
(43) Pub. Date: Feb. 6, 2003

(54) Brake installation with electropneumatic modulator

(76) Inventors: Friedbert Roether, Cleebronn (DE); Siegmund Deja, Freiberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/191,754

(22) Filed: Jul. 10, 2002

(30) Foreign Application Priority Data
Jul. 10, 2001 (DE) 101 33 440.0

(51) Int. Cl. B60T 13/74

(52) U.S. Cl. 303/15; 303/7; 303/9; 188/151 A

(57) ABSTRACT

An electropneumatic brake system for motor vehicles includes a multiple-circuit service brake and a foot activated braking power transmitter that provides the desired brake pressure values pneumatically and electrically. The braking power transmitter is connected at least to one braking circuit which has pneumatic brakes on at least two vehicle axles, including at least one electric, sensor-influenced control device and including electromagnetic valves that are combined in modulators for adjusting or controlling the compressed air that is supplied to the brake cylinders. During normal drive operation, the modulators allocate the compressed air electrically to the brakes while, during emergency operation, the modulators allocate the compressed air pneumatically to the brakes. The brake system has at least two separate pneumatic braking circuits, which can make due with relatively few modules and short compressed-air paths.

### BACKGROUND AND SUMMARY OF THE INVENTION

This application claims the priority of German Application No. 101 33 440.0, filed Jul. 10, 2001, the disclosure of which is expressly incorporated by reference herein.

The invention relates to an electropneumatic brake system for motor vehicles. Such a system is comprised of a multiple-circuit service brake and a foot-pedal-activated braking power transmitter that provides the desired brake pressure values pneumatically and electrically. The braking power transmitter is connected at least to one braking circuit which has pneumatic brakes on at least two vehicle axles. The braking circuit includes at least one electric, sensor-influenced control device and electromagnetic valves that are combined in modulators for adjusting or controlling the compressed air that is supplied to the brake cylinders. During normal drive operation, the modulators allocate electrically the compressed air to the brakes, while during emergency operation, the modulators allocate pneumatically the compressed air to the brakes.

A compressed-air brake installation is known in the art from German Patent document DE 40 03 122 A1. In DE '122, an electronically adjusted electronic control unit has at its disposal electropneumatic converters for distributing and supplying compressed air. The converters are arranged on the front axle and the back axle at each side of the wheel, respectively, and are triggered electrically during normal drive operation. Moreover, also present are two braking circuits. One of these braking circuits is able to supply the wheel-side electropneumatic converters of the front axle and of the rear axle with compressed air by way of a foot-pedal-activated braking power transmitter with an electric desired value transmitter and a service air brake valve. All of the electropneumatic converters and additional 2/2-port directional control valves are triggered via a control unit.

Compressed-air brake installations of this type require a large amount of inter-linked compressed-air lines as well as a complex electronic central control unit. They are characterized by the multitude of the electric valves that are used.

Therefore, it is an object of the present invention to provide a brake system that is comprised of at least two separate pneumatic braking circuits with only a few modules and whose compressed-air lines are kept as short as possible.

This object is achieved by an electropneumatic brake system for motor vehicles comprised of a multiple-circuit service brake and a foot-(pedal-)activated braking power transmitter that provides the desired brake pressure values pneumatically and electrically. The braking power transmitter is connected to at least one braking circuit which has pneumatic brakes on at least two vehicle axles. The braking circuit includes at least one electric, sensor-influenced control unit and includes electromagnetic valves that are combined in modulators for adjusting or controlling the compressed air that is conducted to the brake cylinders. The modulators allocate the compressed air to the brakes, in particular electrically during normal drive operation and pneumatically during emergency operation. A brake control unit is arranged in at least one electropneumatic modulator that combines at least a first and a second braking circuit. The brake control unit allocates the compressed air to both brakes on at least one vehicle axle of the vehicle. At least two pistons are arranged in a housing in the brake control unit that separate the first braking circuit pneumatically from the second braking circuit.

To accomplish this, a brake control unit is arranged in at least one electropneumatic modulator that combines at least a first and a second braking circuit. At least on one vehicle axle, this brake control unit supplies both brakes of that vehicle axle with compressed air. At least two pistons are arranged inside the housing of this brake control unit providing a pneumatic divide between the first braking circuit and the second braking circuit.

During normal drive operation, a first braking circuit directly supplies a brake control unit of an electropneumatic modulator of the rear axle with compressed air. A second braking circuit supplies the brake control unit of the electropneumatic modulator of the front axle with compressed air. During a braking operation, the electronic control units of the electropneumatic modulator receive the corresponding control signals via an electric desired value transmitter and via a central control unit. Each modulator has control valve arrangements that distribute—via these control signals—the compressed air, which is supplied by the braking circuits, by way of flexible lines to the brake cylinders.

The electropneumatic modulator of the rear axle is a closed subassembly that is comprised of an electronic control unit, two pilot valve arrangements and two brake control units including ventilation and sound absorption elements. All subassemblies referred to above are directly integrated into one component utilizing the shortest pneumatic and electric connections possible. The closed subassembly of the electropneumatic modulator of the front axle is comprised of an electronic control unit, a group of pilot valves and a brake control unit. Since no further valves or additional control or adjustment units are necessary in the present context, the short pneumatic and electric paths allow for achieving especially short reaction times. The small number of valves and compressed-air lines also allows for particularly easy handling during assembly and service.

The brake control unit of the front axle and a brake control unit of the rear axle also have one additional compressed-air connection, respectively, of the first braking circuit. During emergency operation, these compressed-air connections are used, via a mechanically activated service valve, for the pneumatic control of the brake control units. Normally, provided several braking circuits are employed, electropneumatic brake systems of this kind always have two separate brake control units. In contrast to the prior art, the present invention combines two separate braking circuits in only one brake control unit.

The compressed air of the first braking circuit controls inside the brake control unit via an arrangement of valve parts the compressed-air supply of the brake cylinders via the second braking circuit. If the two braking circuits are combined in only one brake control unit, no pneumatic pressure may be transferred from one braking circuit to the other braking circuit. The division is achieved by employing several pistons that influence one another and that, on the one hand, allocate air to the brake cylinders while, on the other hand, venting air leakage to the outside.

If these pistons are arranged in a particular way and, using other integrated pilot valves, it is possible to use short electric and pneumatic connecting lines. The arrangement supports targeted, quickly changing compressed-air switching processes of the kind that are also in use in connection with ABS automatic controls.

Other objects, advantages and novel features of the present invention will become apparent from the following detailed description of the invention when considered in conjunction with the accompanying drawings.

### BRIEF DESCRIPTION OF THE DRAWINGS

FIG. 1 is a circuit diagram of a two-circuit brake installation; and

FIG. 2 is an electropneumatic modulator for use in the circuit of FIG. 1, including a functional diagram of a brake control unit.

### DETAILED DESCRIPTION OF THE DRAWINGS

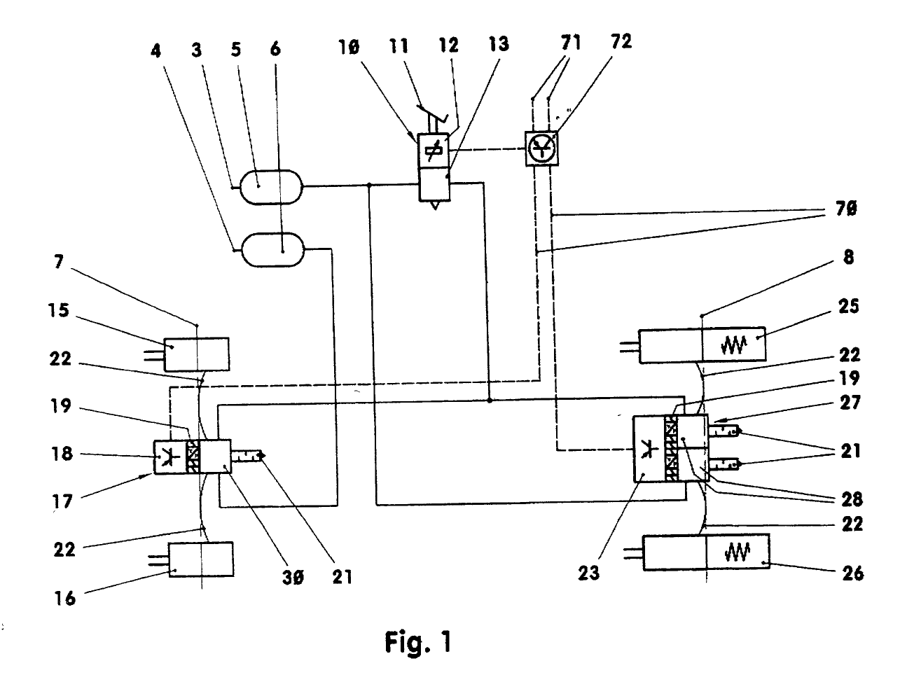

FIG. 1 shows an electric-pneumatic brake system that is comprised of an electropneumatic braking power transmitter (10), which is equipped with a brake pedal (11), an electric desired value transmitter (12) and a service air brake valve (13). A supply container (5) of a first braking circuit (3) is coupled to the pneumatic input of the service air brake valve (13), as well as a junction point for a line connected to a two-circuit electropneumatic modulator (27) of a rear axle (8) in series therewith. The output of the service air brake valve (13) branches-off into the respective inputs of the electropneumatic modulators (17) and (27). The electropneumatic modulator (17) belongs to the front axle (7).

Two brake cylinders (15, 16) are assigned to the front axle (7); and they are connected via flexible lines (22) to the electropneumatic modulator (17) of the front axle (7).

The electropneumatic modulator (17) has a one-channel design that includes subassemblies of a brake control unit (30), a pilot valve arrangement (19), an electronic control unit (18) and a ventilation element having sound absorption (21). Via the supply containers (5, 6), the brake control unit (30) is connected to first and second independent braking circuits (3, 4).

Two spring-loaded brake cylinders (25, 26), for example, are assigned to the rear axle (8) and are connected to the electropneumatic modulator (27) of the rear axle (8) via the flexible lines (22). The electropneumatic modulator (27) of the rear axle (8) is set up with a two-channel design and is comprised of two brake control units (28), two pilot valve arrangements (19), a joint electronic control unit (23) and two ventilation elements having sound absorption elements (21). Each of these brake control units (28) is connected to the first braking circuit (3), one being connected to the first braking circuit (3) before the braking power transmitter (10) while the other brake control unit (28) is connected with the first braking circuit (3) after the braking power transmitter (10).

To achieve asymmetrical pressure distribution, it is possible to connect pressure control valves between the brake cylinders (15, 16). During ABS operation, these pressure control valves are able to asymmetrically build-up and break-down the brake pressure in the two brake cylinders (15, 16).

Electric signals are fed into a central control unit (72) via sensor inputs (71), which can be transmitted as control signals via the control lines (70) to the electropneumatic modulators (17, 27).

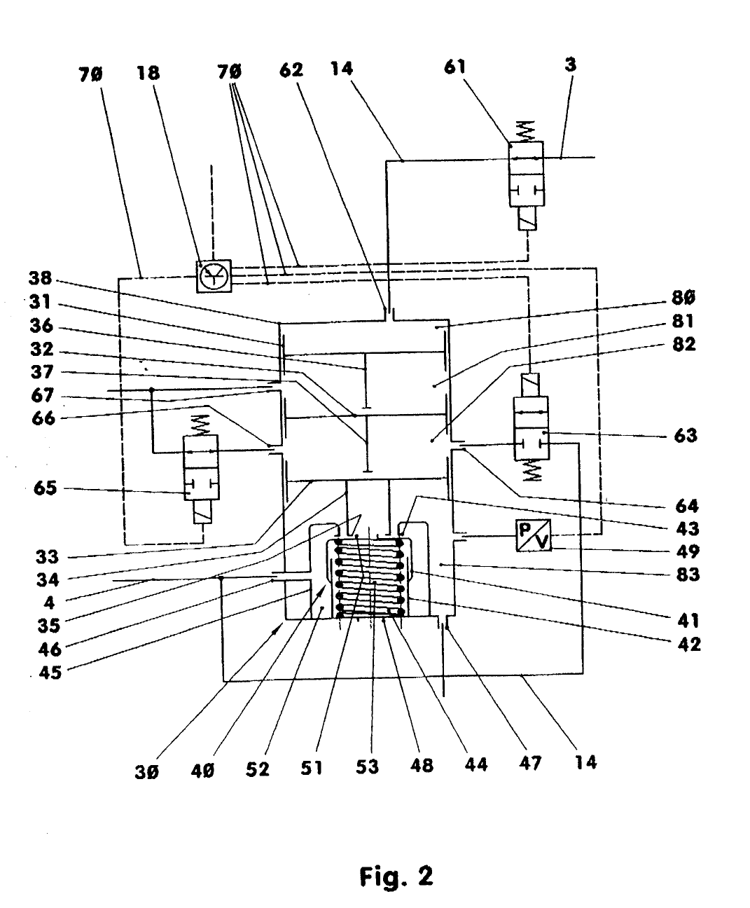

FIG. 2 shows, among other things, a schematic depiction of the electropneumatic modulator (17) including the brake control unit (30) with the associated pilot valves and the electronic control unit (18).

The brake control unit (30) is comprised, in essence, of the pistons (31, 32) and a relay valve (40). The latter is comprised, in essence, of a piston valve (33) with hollow-cylindrical piston rod (34) and a collar (41). All pistons (31, 32, 33, 41) are arranged in series. The pistons (31, 32) have piston rods (36, 37), respectively, on the side that is directed towards the relay valve (40). The hollow-cylindrical piston rod (34) of the piston valve (33) is arranged on the bottom end of the valve seat (35) of the piston valve. The collar (41) has, for example, the shape of a pot and is equipped with a ventilation bore hole (51) on its floor. A guide cylinder (42) is incorporated inside the collar (41) that guides and supports the collar (41) on the housing (38) of the brake control unit (30). Below the guide cylinder (42) is a ventilation opening (48) inside the housing (38) of the brake control unit (30).

A valve spring (44) in mounted inside the guide cylinder (42), which valve spring is clamped and preloaded between the floor of the pot of the collar (41) and the housing (38).

The guide cylinder (42) and the collar (41) are surrounded, for example, by a ring-shaped wall (45) that is arranged on a ring-shaped contact location in relation to the collar (41) as a housing valve seat (43). A ring space (52) is available between the wall (45) and the collar (41) and guide cylinder (42). This ring space (52) is connected to the second braking circuit (4) via a connection (46).

The piston chamber (83) is bordered by the wall (45) of the housing (38) and the piston valve (33) with the hollow-cylindrical piston rod (34). Via the exit (47), the piston chamber has a pneumatic connection to the brake cylinders (15, 16). A pressure sensor (49), assigned to the piston chamber (83), is connected to the electronic control unit (18) by way of a control line (70).

A piston chamber (82) is located between the pistons (32, 33) and the housing (38). This piston chamber (82) is assigned to an inlet valve (63) with the design of the electrically triggered 2/2-port directional control valve via a connection (64). The inlet valve (63) is connected to the second braking circuit (4) by way of a compressed-air line (14) and can be brought into the blocked position using a readjusting spring. Another electrically triggered 2/2-port directional control valve is assigned via the connection (66) to the same piston chamber (82) as a ventilation valve (65). This ventilation valve (65) is open in a currentless state. The piston chamber (81) that is bordered by the pistons (31, 32) and the housing (38) has a permanently open ventilation connection (67). A piston chamber (80) that is formed by the piston (31) and the housing (38) is connected via a connection (62) and a compressed-air line (14′) to a back-up valve (61) to the first braking circuit (3).

The back-up valve (61) is a 2/2-port directional control valve with spring readjustment that can be electrically triggered. In its currentless state, it is switched to flow-through. All electropneumatically activated 2/2-port directional control valves (61, 63, 65) are connected to the electronic control unit (18) via control lines (70).

If need be, the back-up valve (61) can be omitted, provided the pneumatic area of effectiveness of the piston (32) is larger than that of the piston (31).

During normal drive operation, activating the brake pedal (11) (refer to FIG. 1) will cause electric signals to be transmitted via the electric desired value transmitter (12) to the central control unit (72). After processing of these signals, the central control unit (72) transmits control signals to the electronic control units (18, 23) of the electropneumatic modulators (17, 27), which in turn effect triggering of pilot valve arrangements (19) in accordance with these signals, thereby activating the brake control units (30, 28) for the supply of compressed air from the first and second braking circuits (3, 4) to the brake cylinders (15, 16, 25, 26).

During normal drive operation, the electronic control unit triggers—with activated braking power transmitter (10)—the back-up valve (61) electrically via a control line (70), thus switching it permanently to blocking. The compressed-air line (14′) and the piston chamber (80) are without pressure. The piston chamber (81) is continuously maintained without pressure by way of the ventilation connection (67).

With the second braking circuit (4), via connection (46), the ring space (52) is permanently pressurized. The valve spring (44) pushes the collar (41) of the relay valve (40) against the housing valve seat (43), effecting a sealing action. The inlet valve (63) is blocked by the readjusting spring, which means that the brake pressure of the second braking circuit (4) that is permanently applied to the inlet valve (63) cannot be conducted into the piston chamber (82). A braking operation that is triggered during normal drive operation provides the inlet valve (63), via the electronic control unit (18) and the control line (70), with a switching signal, causing the inlet valve (63) to be switched to flow-through. The piston chamber (82) is filled with compressed air via the connection (64), thereby moving the piston (32) in the direction of the piston (31) until both pistons (32, 31) are moving, due to the forming of a block, in the direction of the connection (62). The movement of the two pistons (32, 31) is ensured due to the ventilation of the piston chamber (81) and the unpressurized piston chamber (80). Simultaneously, pressure is applied to the piston valve (33), and it is moved in the direction of the relay valve (40). The hollow-cylindrical piston rod (34) of the piston valve (33) makes contact with the valve seat of the piston valve (35) forming a seal on the floor of the pot of the relay valve (40). The piston chamber (83) is vented via the ventilation opening (48). The chamber (53) that is enclosed by the piston valve (33), the hollow-cylindrical piston rod (34), the collar (41) and the guide cylinder (42) is maintained as unpressurized via the ventilation opening (48).

Due to the pressure prevailing inside the piston chamber (82), the piston valve (33), along with its cylindrical piston rod (34) and the collar (41), is displaced against the valve spring (44) in the direction of the ventilation opening (48). This way, the pressure of the second braking circuit (4) that is applied in the ring space (52) reaches, via the opened, ring-shaped sealing location of the housing valve seat (43), the piston chamber (83) that is pneumatically connected to the brake cylinders (15, 16). During this process, with the electronic control unit (18), the ventilation valve (65) is switched to blocking.

The pressure values that are determined by the pressure sensor (49) are fed to the electronic control unit (18) via the control line (70). If the brake pressure inside the piston chamber (83) is too high, it causes the blocking of the inlet valve (63) while, simultaneously, the electronic control unit (18) switches the ventilation valve (65) to a currentless state. The readjusting spring switches the ventilation valve (65) to flow-through. If brake pressures vary, these switching operations can effect a brake pressure that remains approximately the same. Moreover, with targeted and quickly alternating switching processes of the inlet valve (63) and of the ventilation valve (65), it is possible to achieve a brake control that is similar to ABS.

If there is a disruption—e.g. loss of electric voltage—, emergency operation is ensured due to the fact that the service brake valve (13) can be activated mechanically, as seen from FIG. 1. The brake control unit (30) of the electropneumatic modulator (17) is triggered via the service air brake valve (13) utilizing the compressed air of the first braking circuit (3) in order to connect the second braking circuit (4) for the actual supply of brake pressure to the brake cylinders (15, 16). The brake control units (28) of the electropneumatic modulator (27) are both supplied with compressed air for activating the spring-loaded brake cylinders (25, 26) via the first braking circuit (3) and triggered via the service air brake valve (13).

During emergency operation, neither the central control unit (72) nor the electronic control unit (18) are transmitting switching signals for triggering the piston valve arrangement (19). In this case, triggering of the electropneumatic modulators (17, 27) occurs via the service air brake valve (13) that conducts compressed air of the first braking circuit (3) to the brake control units (30, 28).

A back-up valve (61) is arranged ahead of the service brake control unit (30) and switched currentless to flow-through. Consequently, compressed air of the first braking circuit (3) can reach the piston chamber (80) of the brake control unit (30) via the connection (62). In this context, the piston (31) is displaced in the direction of the relay valve (40) until this piston (31) makes contact with the piston (32) by way of its piston rod (36). The piston chamber (81) is maintained unpressurized utilizing the ventilation connection (67). The pistons (31) and (32) now set to blocking (and which can also be realized as a one-piece component), are now moving jointly toward the relay valve (40) until the piston (32) makes contact with the control piston (33) by way of its piston rod (37). The volume of the piston chamber (82) becomes smaller because of this, but it is not supplied with the brake pressure of the second braking circuit (4)—as occurs during normal drive operation—via the inlet valve (63). During emergency operation, due to its readjusting spring, the inlet valve (63) is in the blocked position. To ensure the safe displacement of the pistons (31, 32), the piston chamber (82) is maintained unpressurized via the ventilation valve (65), which is switched to flow-though by way of the readjusting spring. The block formation of the pistons (31, 32, 33) and of their piston rods (36, 37) effects a displacement of the hollow-cylindrical piston rod (34) in the direction of the collar (41). In this way, the hollow-cylindrical piston rod (34) locks the piston chamber (83) off from the ventilation (48) via the valve seat of the piston valve (35), effecting a seal, and moves the collar (41) out of its blocked position during the further process.

In its blocked position, the collar (41), which is held in its resting position via the valve spring (44), seals the ring space (52) at the housing valve seat (43), which ring space is supplied with pressure via the second braking circuit (4).

The brake pressure of the second braking circuit (4) that prevails permanently inside the ring space (52) is now conducted into the piston chamber (83) from where a direct pressure application to the brake cylinders (15, 16) is achieved via the flexible lines (22), compare FIG. 1. Before the braking action occurs, the brake cylinder (15, 16), the flexible lines (22) and the piston chamber (83) are maintained unpressurized via the opened valve seat of the piston valve (35) and the ventilation (48). The pressure sensor (49) that is assigned to the piston chamber (83) is without function during emergency operation.

The electropneumatic modulator (17) is equipped with only one brake control unit (30) that is supplied with brake pressure from the two separate braking circuits (3, 4) during emergency operation. In such instances, legal safety provisions call for a separation of the two braking circuits (3, 4). Thus, the piston (32) is envisioned in the brake control unit (30) in order to effect a pneumatic separation and to prevent, thereby, any possible compressed air transfer from one braking circuit to another braking circuit. If pressure is applied to the piston chamber (80) via the first braking circuit (3) and any leakage enters the piston chamber (81), the ventilation connection (67) will ensure that the piston chamber (81) is ventilated. The piston (32) that works as a separating component—for the two braking circuits—prevents any overflow into the piston chamber (82). The same principle is envisioned for separating the second braking circuit (4) when, via the inlet valve (63) and the connection (64), compressed air is supplied from the second braking circuit (4) into the piston chamber (82). In this case, the ventilation valve (65), which is connected to the piston chamber (82) via the connection (66), is switched to the blocked position. Any leakage that may occur in this instance on the piston (32) would be disposed of in the same way via the ventilation connection (67). Arranging a separating piston (32) and a ventilation connection (67) in the piston chamber (81) is sufficient for safely separating the two braking circuits (3, 4), because compressed air can be applied either in the piston chamber (80) or in the piston chamber (82). With the wiring of the pilot valves (19), it is ensured that no pressure application is ever in effect on both braking circuits 1 and 2 (3, 4) with regard to the corresponding piston chamber (80, 82) during normal drive operation as well as during emergency operation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electropneumatic brake system for a motor vehicle, comprising:
a braking power transmitter providing desired brake pressure values pneumatically and electrically;
a multiple-circuit service brake, one circuit being connected to the braking power transmitter and having pneumatic brakes on at least two vehicle axles, wherein said one braking circuit includes an electric control unit and electromagnetic valves for adjusting or controlling compressed air conducted to brake cylinders;
wherein a brake control unit is arranged in at least one electropneumatic modulator combining at least a first and a second braking circuit, the modulator allocating electrically the compressed air to the pneumatic brakes during normal drive operation and pneumatically during emergency drive operation, and further wherein the brake control unit allocates the compressed air to both brakes on at least one vehicle axle of the vehicle; and
at least two pistons arranged in a housing of the brake control unit, the at least two pistons separating the first braking circuit pneumatically from the second braking circuit.

2. The brake system according to claim 1, further comprising a third piston, wherein inside the housing the first piston, the second piston and the third piston are arranged in series and at a distance to each other, said pistons being guided inside the housing with a sealing action, and said pistons being held at a distance from one another by way of piston rods.

3. The brake system according to claim 2, further comprising a relay valve arranged at an end of the series of pistons, the relay valve causing, when activated, compressed air of the second braking circuit, electrically controlled, to be allocated to the brakes.

4. The brake system according to claim 2, wherein at least one of said pistons activates a relay valve, and the third piston makes contact with an adjusting element of the relay valve.

5. The brake system according to claim 3, wherein at least one of the pistons activates the relay valve, and the third piston makes contact with an adjusting element of the relay valve.

6. The brake system according to claim 2, wherein a compressed-air connection of the second braking circuit and a ventilation connection are arranged between the second piston and the third piston inside the housing, both connections being blockable independently of each other.

7. The brake system according to claim 3, wherein a compressed-air connection of the second braking circuit and a ventilation connection are arranged between the second piston and the third piston inside the housing, both connections being blockable independently of each other.

8. The brake system according to claim 4, wherein a compressed-air connection of the second braking circuit and a ventilation connection are arranged between the second piston and the third piston inside the housing, both connections being blockable independently of each other.

9. The brake system according to claim 2, wherein a ventilation connection is arranged between the first piston and the second piston inside the housing.

10. The brake system according to claim 3, wherein a ventilation connection is arranged between the first piston and the second piston inside the housing.

11. The brake system according to claim 4, wherein a ventilation connection is arranged between the first piston and the second piston inside the housing.

12. The brake system according to claim 6, wherein a second ventilation connection is arranged between the first piston and the second piston inside the housing.

13. The brake system according to claim 2, wherein compressed air of the first braking circuit can be applied to the first piston on a side that is directed away from the second piston, via a compressed-air connection that is blockable.

14. The brake system according to claim 3, wherein compressed air of the first braking circuit can be applied to the first piston on a side that is directed away from the second piston, via a compressed-air connection that is blockable.

15. The brake system according to claim 4, wherein compressed air of the first braking circuit can be applied to the first piston on a side that is directed away from the second piston, via a compressed-air connection that is blockable.

16. The brake system according to claim 1, wherein the electropneumatic modulator comprises at least the brake control unit connections, blocking or releasing valves of the electronic control unit, and a pressure sensor.

17. The brake system according to claim 1, wherein the two pistons are a one-piece component.

18. The brake system according to claim 1, wherein a first piston has a larger pneumatic area of effectiveness than a second piston.

19. A brake system, comprising:
a first braking circuit;
a second braking circuit;
at least one electropneumatic modulator combining the first and second braking circuits;
a brake control unit having a housing arranged in the electropneumatic modulator, the brake control unit supplying both brakes of at least one vehicle axle with compressed air;
first and second pistons arranged inside the housing of the brake control unit, the first and second pistons pneumatically separating the first braking circuit from the second braking circuit.

20. The brake system according to claim 19, further comprising:
a third piston inside the housing, the first, second and third pistons being arranged in series and at a distance with respect to each other, the pistons affecting a sealing action with the housing and being held at the distance with respect to each by way of respective piston rods.

21. The brake system according to claim 20, further comprising:
a relay valve arranged at an end of the series of pistons, the relay valve allocating compressed air of the second braking circuit to the brakes under electric control when activated.

22. The brake system according to claim 21, wherein one of the first, second and third pistons is operatively coupled to activate the relay valve, and further wherein the third piston makes contact with an adjusting element of the relay valve.

23. The brake system according to claim 20, further comprising a compressed-air connection of the second braking circuit and a ventilation connection, the connections being arranged between the second piston and the third piston inside the housing and being blockable independently of each other.

24. The brake system according to claim 23, further comprising another ventilation connection arranged between the first piston and the second piston inside the housing.

25. The braking system according to claim 19, wherein compressed air of the first braking circuit is applyable to the first piston on a side facing away from the second piston via a blockable compressed-air connection.

26. The braking system according to claim 20, wherein compressed air of the first braking circuit is applyable to the first piston on a side facing away from the second piston via a blockable compressed-air connection.

27. The braking system according to claim 21, wherein compressed air of the first braking circuit is applyable to the first piston on a side facing away from the second piston via a blockable compressed-air connection.

28. The brake system according to claim 19, further comprising another electropneumatic modulator having another brake control unit for another axle of the vehicle; and
wherein during normal drive operation, the first braking circuit directly supplies the brake control unit of said another electropneumatic modulator with compressed air, and the second braking circuit supplies the brake control unit of the electromagnetic modulator with compressed air.
